(19) United States
(12) Patent Application Publication
(10) Pub. No.: US 2020/0372270 A1
(43) Pub. Date: Nov. 26, 2020

(54) IN-VEHICLE SYSTEM

(71) Applicant: Yazaki Corporation, Tokyo (JP)

(72) Inventors: Masaki Saito, Shizuoka (JP); Kentaro Otomo, Shizuoka (JP); Atsushi Ishibashi, Shizuoka (JP); Yu Kawahara, Shizuoka (JP); Shinichi Okamoto, Shizuoka (JP)

(73) Assignee: Yazaki Corporation, Tokyo (JP)

(21) Appl. No.: 16/990,413

(22) Filed: Aug. 11, 2020

Related U.S. Application Data
(63) Continuation of application No. PCT/JP2019/002102, filed on Jan. 23, 2019.

(30) Foreign Application Priority Data
Mar. 12, 2018 (JP) 2018-043902

(51) Int. Cl. G06K 9/00; G06K 9/46; B60W 60/00

(52) U.S. Cl. CPC G06K 9/00825; G06K 9/4661; B60W 2420/42; B60W 2554/4045; B60W 2554/408; B60W 60/0027

(57) ABSTRACT

An in-vehicle system includes: a first detection unit that detects an illumination state of another vehicle on the basis of an image obtained by capturing a nearby image of a vehicle; a second detection unit that detects a traffic situation of the vehicle; an estimation unit that estimates intention of a signal of the other vehicle on the basis of the illumination state of the other vehicle that is detected by the first detection unit and the traffic situation of the vehicle that is detected by the second detection unit; and operation units that perform processing corresponding to intention of a signal of the other vehicle that is estimated by the estimation unit. As a result, it is possible to attain an effect in which it is not necessary for the in-vehicle system to perform communication with the other vehicles to confirm the signal of the other vehicles.

### CROSS-REFERENCE TO RELATED APPLICATION

This application is a continuation application of International Application PCT/JP2019/002102, filed on Jan. 23, 2019 which claims the benefit of priority from Japanese Patent application No. 2018-043902 filed on Mar. 12, 2018 and designating the U.S., the entire contents of which are incorporated herein by reference.

### BACKGROUND OF THE INVENTION

### 1. Field of the Invention

The present invention relates to an in-vehicle system.

### 2. Description of the Related Art

In the related art, as signals for exchanging communication between drivers, passing, horn, and the like have been used. However, the signals are used in various meanings by human beings, and have no clear definition, and thus the signals may not be accurately transmitted to a counterpart. Accordingly, there is known a vehicle communication device that uses inter-vehicle communication, and transmits information corresponding to a driver's operation to a vehicle in front of a host vehicle to transmit an intention of the host vehicle. For example, Japanese Patent Application Laid-open No. 2005-215753 discloses a vehicle communication device that transmits intention (message) on a host vehicle side which is included in an operation such as the passing and the horn to a desired transmission counterpart.

The vehicle communication device described in Japanese Patent Application Laid-open No. 2005-215753 cannot transmit intention of the host vehicle side to a counterpart side, for example, in a case where a transmission and reception device is not mounted on both vehicles. As described above, with regard to delivery of intention included in a vehicle operation, there is room for an improvement.

### SUMMARY OF THE INVENTION

The invention has been made in consideration of such circumstances, and an object thereof is to provide an in-vehicle system capable of estimating intention of a signal of other vehicles.

In order to solve the above mentioned problem and achieve the object, an in-vehicle system according to one aspect of the present invention includes a first detection unit that detects an illumination state of another vehicle on the basis of an image obtained by capturing a nearby image of a vehicle; a second detection unit that detects a traffic situation of the vehicle; an estimation unit that estimates intention of a signal of the other vehicle on the basis of the illumination state of the other vehicle that is detected by the first detection unit and the traffic situation of the vehicle that is detected by the second detection unit; and an operation unit that performs processing corresponding to the intention of the signal of the other vehicle that is estimated by the estimation unit, wherein the operation unit controls automatic travel of the vehicle on the basis of the intention of the signal of the other vehicle that is estimated by the estimation unit.

According to another aspect of the present invention, in the in-vehicle system, it is preferable that the operation unit controls outputting of information indicating the intention of the signal of the other vehicle that is estimated by the estimation unit.

According to still another aspect of the present invention, in the in-vehicle system, it is preferable that the in-vehicle system further includes a front camera that captures an image in front of the vehicle, and a rear camera that captures an image on a backward side of the vehicle, wherein the first detection unit detects the illumination state of the other vehicle on the basis of at least one of the image captured by the front camera and the image captured by the rear camera.

According to still another aspect of the present invention, in the in-vehicle system, it is preferable that the estimation unit estimates the intention of the signal of the other vehicle on the basis of the illumination state of the other vehicle that is detected by the first detection unit, the traffic situation of the vehicle that is detected by the second detection unit, and an illumination state of a headlight of the vehicle.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of an in-vehicle system according to an embodiment;

FIG. 2 is a view illustrating an example of estimation information that is used by the in-vehicle system according to the embodiment;

FIG. 3 is a flowchart illustrating an example of control of a control device of the in-vehicle system according to the embodiment; and

FIG. 4 is a flowchart illustrating another example of the control of the control device of the in-vehicle system according to the embodiment.

### DETAILED DESCRIPTION OF THE PREFERRED EMBODIMENTS

Hereinafter, an embodiment of the invention according to the invention will be described in detail with reference to the accompanying drawings. Furthermore, the invention is not limited by the embodiment. In addition, constituent elements in the following embodiment include a constituent element that can be easily substituted by those skilled in the art, or substantially the same constituent element.

### Embodiment

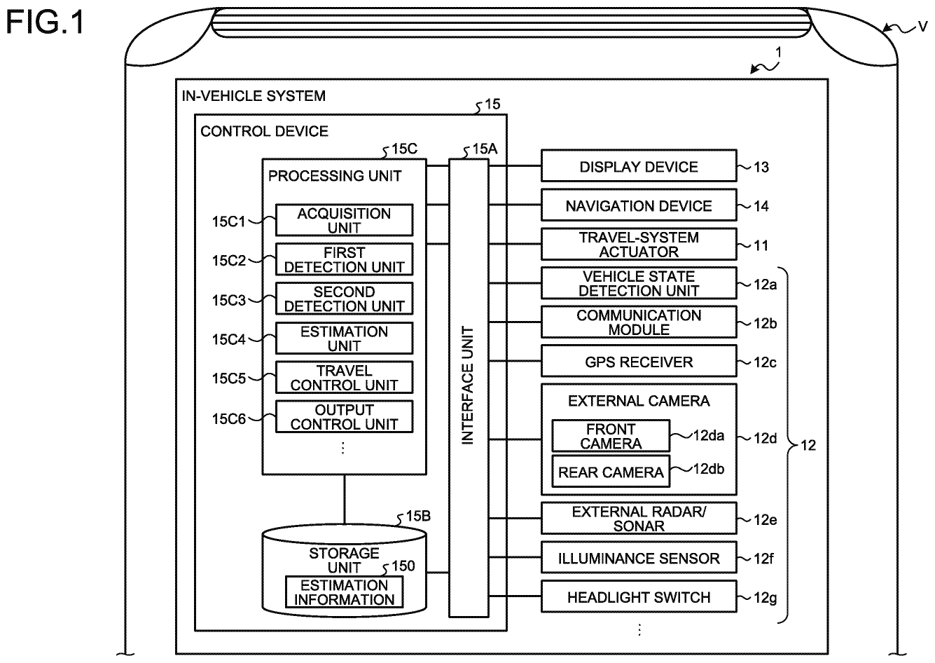

An in-vehicle system 1 of this embodiment illustrated in FIG. 1 is a system that is applied to a vehicle V. The vehicle V to which the in-vehicle system 1 is applied may be any vehicle such as an electric vehicle (EV), a hybrid electric vehicle (HEV), a plug-in hybrid electric vehicle (PHEV), a gasoline vehicle, and a diesel vehicle which use a motor or an engine as a drive source. In addition, driving of the vehicle V may be any driving such as manual driving by a driver, semi-automatic driving, and full-automatic driving. In addition, the vehicle V may be any one of a private vehicle that is carried by a so-called individual, a rent car, a sharing car, a bus, a truck, a taxi, and a ride shared car.

In the following description, as an example, description will be given on the assumption that the vehicle V is a vehicle for which automatic driving (semi-automatic driving, full-automatic driving) is possible. The in-vehicle system 1 assumes intension of a signal of other vehicles to realize the so-called automatic driving in the vehicle V. The in-vehicle system 1 is realized by mounting constituent elements illustrated in FIG. 1 on the vehicle V. Hereinafter, respective configurations of the in-vehicle system 1 will be described in detail with reference to FIG. 1. In the following description, the vehicle V may be noted as “host vehicle” in some cases.

Furthermore, in the in-vehicle system 1 illustrated in FIG. 1, a connection method between respective constituent elements for power supply, and transmission and reception of control signals, various pieces of information, and the like may be any one of wired connection through a wiring material such as an electric wire and an optical fiber (including, for example, optical communication through the optical fiber, and the like), wireless communication, and wireless connection such as non-contact power supply unless otherwise stated.

In the following description, description will be given of an example of a case where the in-vehicle system 1 is an automatic driving system.

The in-vehicle system 1 is a system that realizes automatic driving in the vehicle V. The in-vehicle system 1 is realized by mounting the constituent elements illustrated in FIG. 1 on the vehicle V. Specifically, the in-vehicle system 1 includes a travel-system actuator 11, a detection device 12, a display device 13, a navigation device 14, and a control device 15. Furthermore, in the in-vehicle system 1, the display device 13 and the navigation device 14 may be realized by one display equipment.

The travel-system actuator 11 corresponds to various devices for allowing the vehicle V to travel. Typically, the travel-system actuator 11 includes a travel power train, a steering device, a braking device, and the like. The travel power train is a drive device that allows the vehicle V to travel. The steering device is a device that realizes steering of the vehicle V. The braking device is a device that performs braking of the vehicle V.

The detection device 12 detects various pieces of information. For example, The detection device 12 detects vehicle state information, nearby situation information, and the like. The vehicle state information is information indicating a travel state of the vehicle V. The nearby situation information is information indicating a nearby situation of the vehicle V. For example, the vehicle state information may include vehicle speed information of the vehicle V, acceleration (acceleration in a vehicle front and rear direction, acceleration in a vehicle width direction, acceleration in a vehicle rolling direction, and the like) information, steering angle information, accelerator pedal operation amount (accelerator stepping amount) information, brake pedal operation amount (brake stepping amount) information, shift position information, current value/voltage value information of respective units, electricity storage amount information of an electrical storage device, and the like. For example, the nearby situation information may include nearby image information obtained by capturing an image of a nearby environment of the vehicle V or an external object such as a person, other vehicles, and an obstacle at the periphery of the vehicle V, external object information indicating presence and absence of the external object or a relative distance from the external object, a relative speed, and time-to-collision (TTC), and the like, white-line information of a lane in which the vehicle V travels, traffic information of a travel road on which the vehicle V travels, current position information (GPS information) of the vehicle V, and the like.

As an example, the detection device 12 illustrated in FIG. 1 includes a vehicle state detection unit 12a, a communication module 12b, a GPS receiver 12c, an external camera 12d, and an external radar/sonar 12e, an illuminance sensor 12f, and a headlight switch 12g.

The vehicle state detection unit 12a detects vehicle state information including vehicle speed information, acceleration information, steering angle information, accelerator pedal operation amount information, brake pedal operation amount information, shift position information, current value/voltage value information, electricity storage amount information, and the like. For example, the vehicle state detection unit 12a includes various detectors and sensors such as a vehicle speed sensor, an acceleration sensor, a steering angle sensor, an accelerator sensor, a brake sensor, a shift position sensor, and a current/voltage meter. The vehicle state detection unit 12a may include a processing unit such as an electronic control unit (ECU) that controls respective units in the vehicle V. The vehicle state detection unit 12a may detect winker information indicating a winker state of the host vehicle as the vehicle state information.

The communication module 12b transmits and receives information through wireless communication with external devices of the vehicle V such as other vehicles, on-road devices, cloud devices, and electronic devices carried by persons outside the vehicles V. According to this, the communication module 12b detects nearby situation information including, for example, nearby image information, external object information, and traffic information. For example, the communication module 12b communicates with external devices through various types of wireless communication such as wide-area wireless type and narrow-area wireless type. Here, examples of the wide-area wireless type include a radio (AM, FM), a TV (UHF, 4K, 8K), TEL, GPS, WiMAX (registered trademark), and the like. In addition, examples of the narrow-area wireless type include ETC/DSRC, VICS (registered trademark), wireless LAN, millimeter wave communication, and the like.

The GPS receiver 12c detects current position information indicating a current position of the vehicle V as the nearby situation information. The GPS receiver 12c receives an electric wave transmitted from a GPS satellite to acquire GPS information (latitude/longitude coordinates) of the vehicle V as the current position information.

The external camera 12d captures an image of the periphery of the vehicle V which constitutes the nearby image information, or an image of a travel road surface of the vehicle V which constitutes white-line information as the nearby situation information. For example, the image includes a moving image, a still image, and the like. The external camera 12d includes a front camera 12da that captures an image in front of the vehicle V, and a rear camera 12db that captures an image on a backward side of the vehicle V. For example, the nearby situation information includes a forward image obtained by capturing an image of forward other vehicles travelling in a lane in which the vehicle V travels, and in an opposite lane. For example, the nearby situation information includes a backward image obtained by capturing an image of another vehicle that travels in a lane in which the vehicle V travels. The external camera 12d can capture an image indicating an illumination state of a winker, a head lamp, and a hazard lamp of the other vehicle.

The external radar/sonar 12e detects external object information as the nearby situation information by using infrared rays, millimeter waves, ultrasonic waves, and the like. The illuminance sensor 12f detects nearby illuminance of the vehicle V as the nearby situation information. The headlight switch 12g detects an operation state of a headlight of the vehicle V. The headlight of which an operation is detected by the headlight switch 12g is an illumination device that illuminates a forward side of the vehicle V. The headlight can switch a low beam and a high beam from each other.

The display device 13 is provided in the vehicle V, and can be visually observed from a driver, an occupant, and the like of the vehicle V. Examples of the display device 13 include display devices such as a liquid crystal display, and an organic electroluminescence (EL) display.

The display device 13 can be used, for example, as a combination meter, a head up display, a television, and the like of the vehicle V.

The navigation device 14 is provided in the vehicle V, and has a function of guiding the vehicle V to a destination by displaying a map. The navigation device 14 obtains a route from a current position to a destination on the basis of positional information of the vehicle V, and provides information for guiding the vehicle V to the destination. The navigation device 14 includes map data, and can provide map information corresponding to a current position of the vehicle V to the following processing unit 15C.

The control device 15 collectively controls respective units of the in-vehicle system 1. The control device 15 may be also used as an electronic control unit that collectively controls the entirety of the vehicle V. The control device 15 executes various kinds of operation processing for realizing travelling of the vehicle V. The control device 15 includes an electronic circuit that mainly includes a known microcomputer including a central operation processing device such as a central processing unit (CPU), a micro processing unit (MPU), an application specific integrated circuit (ASIC), a field programmable gate array (FPGA), a read only memory (ROM), a random access memory (RAM), and an interface. The travel-system actuator 11, the detection device 12, the display device 13, and the navigation device 14 are electrically connected to the control device 15. The travel-system actuator 11, the detection device 12, the display device 13, and the navigation device 14 may be electrically connected to the control device 15 through an ECU (for example, a body ECU, and the like) that controls respective units in the vehicle V. The control device 15 can transmit and receive various detection signals or various electric signals such as drive signals for driving respective units to and from respective units.

Specifically, the control device 15 includes an interface unit 15A, a storage unit 15B, and a processing unit 15C in terms of a functional concept. The interface unit 15A, the storage unit 15B, and the processing unit 15C can transmit and receive various pieces of information to and from various devices which are electrically connected thereto.

The interface unit 15A is an interface that transmit and receive various pieces of information to and from respective units of the in-vehicle system 1 such as the travel-system actuator 11 and the detection device 12. In addition, the interface unit 15A can be electrically connected to the display device 13 and the navigation device 14. The interface unit 15A has an information wired communication function with respective units through an electric wire, an information wireless communication function with the respective units through a wireless communication unit and the like.

The storage unit 15B is a storage device of an automatic driving system. For example, the storage unit 15B may be a data rewritable semiconductor memory such as storage devices including a hard disk, a solid state drive (SSD), and an optical disc which have a relatively large capacity, a RAM, a flash memory, and a nonvolatile static random access memory (NVSRAM). The storage unit 15B stores condition or information which is necessary for various kinds of processing in the control device 15, various programs and applications which are executed by the control device 15, control data, and the like. For example, the storage unit 15B stores map information indicating a map which is referenced when specifying a current position of the vehicle V on the basis of a current position information detected by the GPS receiver 12c, estimation information 150 that can be used to estimate intention of a signal of another vehicle to be described later, and the like as a database. In addition, for example, the storage unit 15B may temporarily store various pieces of information detected by the detection device 12, and various pieces of information acquired by an acquisition unit 15C1 to be described later. The above-described various pieces of information are read out from the storage unit 15B by the processing unit 15C and the like as necessary.

The processing unit 15C is a unit that executes various programs stored in the storage unit 15B on the basis of various input signals and the like, and outputs an output signal to respective units in accordance with the operation of the programs to execute various kinds of processing for realizing various functions.

More specifically, the processing unit 15C includes the acquisition unit 15C1, a first detection unit 15C2, a second detection unit 15C3, an estimation unit 15C4, a travel control unit 15C5, and an output control unit 15C6 in terms of a functional concept.

The acquisition unit 15C1 is a unit having a function capable of executing processing of acquiring various pieces of information which are used in various kinds of processing in the in-vehicle system 1. The acquisition unit 15C1 acquires the vehicle state information, the nearby situation information, and the like which are detected by the detection device 12. For example, the acquisition unit 15C1 acquires nearby situation information including an image in front of the vehicle V and an image on a backward side of the vehicle V. The acquisition unit 15C1 can store the acquired various pieces of information in the storage unit 15B.

The first detection unit 15C2 detects an illumination state of another vehicle on the basis of a video (image) obtained by capturing a nearby image of the vehicle V. For example, the illumination state of the other vehicle includes a state of an illumination device which corresponds to a signal that exchanges communication between drivers. For example, the signal includes passing, winker, and hazard. For example, the passing includes instant lighting of a headlight of the other vehicle in an upward direction (high beam), instant switching of the headlight to the upward direction during lighting of the headlight in a downward direction (low beam), and the like. For example, the winker includes a state in which a right or left direction indicator of the other vehicle is flickered. For example, the hazard includes a state in which all of front and rear winkers of the other vehicle are flickered. Furthermore, the first detection unit 15C2 is configured to detect an illumination state of the other vehicle in a case where an object is detected by the external radar/sonar 12e.

The second detection unit 15C3 detects traffic situations of the vehicle V. The second detection unit 15C3 detects traffic situations including a location in which the vehicle V travels, a relative relationship between the vehicle V and the nearby other vehicle, a travel state, and the like on the basis of a video (image) by capturing a nearby image of the vehicle V, current position information of the vehicle V, map information, and the like. In this embodiment, the second detection unit 15C3 can detect a plurality of traffic situations which are indicated by the estimation information 150 that is stored in the storage unit 15B. For example, the traffic situations include a situation in which right-turn waiting another vehicle exists in an opposite lane while the host vehicle is approaching an intersection. For example, the traffic situations include a situation in which a straight-travelling vehicle is approaching an intersection in an opposite lane while lowering a speed when the host vehicle waits right-turn at the intersection. For example, the traffic situations include a situation in which the host vehicle and an oncoming vehicle which travel straight ahead pass each other. For example, the traffic situations include a situation in which another vehicle interrupts the host vehicle on a forward side. For example, the traffic situations include a situation in which another vehicle approaches the host vehicle at a high speed from the backward side in the same lane. For example, the traffic situations include a situation in which other vehicles are stopped in a line on a backward side in the same lane while the host vehicle is stopped.

The estimation unit 15C4 is a unit having a function capable of executing processing of estimating intention of signals of other vehicles on the basis of an illumination state of the other vehicles and a traffic situation of the vehicle V. For example, the estimation unit 15C4 is configured to execute processing of predicting signals of other vehicles at the periphery of the vehicle V by using various artificial intelligence technologies or deep learning technologies which are known. For example, the estimation unit 15C4 estimates intention of a signal of another vehicle at the periphery of the vehicle V on the basis of the estimation information 150 stored in the storage unit 15B and the like. The estimation information is information that reflects a learning result of the intention of the signal of the other vehicle at the periphery of the vehicle V in correspondence with the illumination state of the other vehicle and the traffic situation of the vehicle V by various methods using the artificial intelligence technologies or the deep learning technologies. In other words, the estimation information 150 is database information obtained by various methods using the artificial intelligence technologies or the deep learning technologies to estimate intention of signals of other vehicles at the periphery of the vehicle V on the basis of the illumination state of the other vehicles and the traffic situation of the vehicle V. An example of the estimation information 150 will be described later. For example, the estimation unit 15C4 predicts intension of signals of other vehicles at least one side among a forward side, a backward side, and a lateral side of the vehicle V. The estimation unit 15C4 may estimate the intention of the signals of the other vehicles from a traffic situation of the vehicle V and an illumination state of a headlight and the like. Furthermore, an example in which the estimation unit 15C4 estimates intention of signals of other vehicles will be described later.

The travel control unit 15C5 is a unit having a function capable of executing processing of controlling travel of the vehicle V on the basis of an estimation result of the estimation unit 15C4. The travel control unit 15C5 is an example of an operation unit. The travel control unit 15C5 controls the travel-system actuator 11 on the basis of the information (vehicle state information, nearby situation information, and the like) acquired by the acquisition unit 15C1 to execute various kinds of processing relating to travel of the vehicle V. The travel control unit 15C5 may control the travel-system actuator 11 through an ECU (for example, an engine ECU and the like). The travel control unit 15C5 of this embodiment automatically drives the vehicle V by executing various kinds of processing relating to automatic driving of the vehicle V.

The automatic driving of the vehicle V by the travel control unit 15C5 is driving in which a behavior of the vehicle V is automatically controlled in a state in which priority is given to a driving operation by a driver of the vehicle V on the basis of information acquired by the acquisition unit 15C1, or regardless of the driving operation by the driver. Examples of the automatic driving include semi-automatic driving in which the driving operation by the driver is interposed to a certain extent, and full-automatic driving in which the driving operation by the driver is not interposed. Examples of the semi-automatic driving include driving such as vehicle stability control (VSC), adaptive cruise control (ACC), and lane keeping assist (LKA). Examples of the full-automatic driving include driving in which the vehicle V is allowed to automatically travel to a destination, driving in which a plurality of the vehicles V are allowed to automatically travel in a line, and the like. In the case of the full-automatic driving, the driver may not exist in the vehicle V. In addition, the travel control unit 15C5 of this embodiment performs control in which a motion of the vehicle V which corresponds to an estimation result of intention of signals of other vehicles at the periphery of the vehicle V is reflected on travel of the vehicle V by the estimation unit 15C4. In other words, the travel control unit 15C5 performs automatic driving of the vehicle V on the basis of an estimation result of intention of signals of other vehicles at the periphery of the vehicle V by the estimation unit 15C4.

The output control unit 15C6 is a unit having a function capable of executing processing of outputting information that is estimated by the estimation unit 15C4 and indicates intention of signals of other vehicles at the periphery of the vehicle V. The output control unit 15C6 is an example of an operation unit. The output control unit 15C6 outputs the information indicating intention of signals of other vehicles to the display device 13 through the interface unit 15A. In this embodiment, description is given of a case where the output control unit 15C6 outputs information indicating intention of signals of other vehicles to the display device 13, but there is no limitation thereto. For example, the output control unit 15C6 may output the information indicating intension of signals of other vehicles form a voice output device. For example, the output control unit 15C6 may output information indicating a response to an estimated signal, gist indicating understanding of the intention, and the like to the other vehicles.

For example, the display device 13 displays information that is input from the output control unit 15C6. The display device 13 can deliver intension of signals to a driver, an occupant, and the like of the vehicle V by displaying information indicating the intension of the signals of the other vehicles.

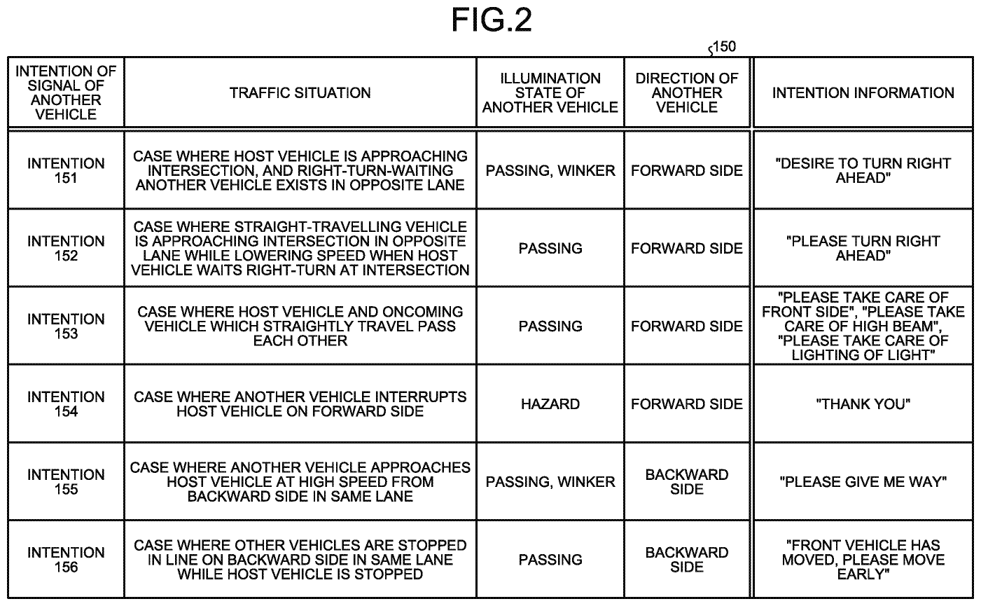

Next, an example of the estimation information 150 stored in the storage unit 15B will be described. As illustrated in FIG. 2, the estimation information 150 is information in which a plurality of intention 151 to intention 156, traffic situations, and illumination states of other vehicles are correlated with each other. The estimation information 150 includes items of traffic situations, illumination states of other vehicles, directions of the other vehicles, and intention information which correspond to the intention 151 to the intention 156.

For example, in a traffic situation item of the intention 151, a traffic situation in which the host vehicle is approaching an intersection, and right-turn-waiting another vehicle exists in an opposite lane is set as a condition. In an item of illumination state of another vehicle in the intention 151, a situation in which the other vehicle performs passing and winker is set as a condition. In an item of direction of another vehicle in the intention 151, a case where the other vehicle exists in front of the vehicle V is set as a condition. In a case where the respective conditions of the intention 151 are satisfied, intention of a signal of another vehicle can be estimated as the intention 151 in which the other vehicle desires to turn right ahead. For example, information indicating intention such as “desire to turn right ahead” is set to an intention information item of the intention 151.

For example, in the traffic situation item of the intention 152, a traffic situation in which a straight-travelling vehicle is approaching an intersection in an opposite lane while lowering a speed when the host vehicle waits right-turn at the intersection is set as a condition. In the item of illumination state of another vehicle in the intention 152, a situation in which the other vehicle performs passing is set as a condition. In the item of direction of another vehicle in the intention 152, a case where the other vehicle exists in front of the vehicle V is set as a condition. In a case where the respective conditions of the intention 152 are satisfied, the intention of a signal of another vehicle can be estimated as the intention 152 in which the vehicle V is encouraged to turn right ahead. For example, information indicating intention such as “please turn right ahead” is set to the item of intention information of the intention 152.

For example, in the traffic situation item of the intention 153, a traffic situation in which the host vehicle and an oncoming vehicle which straightly travel pass each other is set as a condition. In the item of illumination state of another vehicle in the intention 153, a situation in which the other vehicle waits passing as a condition. In the item of direction of another vehicle in the intention 153, a case where the other vehicle exists in front of the vehicle V is set as a condition. In a case where the respective conditions of the intention 153 are satisfied, intention of a signal of another vehicle can be estimated as the intention 153 such as confirmation of a light of the vehicle V and encouraging of attention to a front travelling side of the vehicle V. For example, information indicating any one intention among “please take care of the front side”, “please take care of a high beam”, and “please take care of lighting of a light” is set to the item of intention information of the intention 153.

For example, in the traffic situation item of the intention 154, a traffic situation in which another vehicle interrupts the host vehicle is set as a condition. In the item of illumination state of another vehicle in the intention 154, a situation in which the other vehicle displays hazard is set as a condition. In the item of direction of another vehicle in the intention 154, a case where the other vehicle exists in front of the vehicle V is set as a condition. In a case where the respective conditions of the intention 154 are satisfied, intention of a signal of another vehicle can be estimated as the intention 154 of appreciation with respect to the vehicle V.

For example, information indicating intention of appreciation such as “thank you” is set to the item of intention information of the intention 154.

For example, in the traffic situation item of the intention 155, a traffic situation in which another vehicle approaches the host vehicle at a high speed from a backward side in the same lane is set as a condition. In the item of illumination state of another vehicle in the intention 155, a situation in which the other vehicle displays passing and winker is set as a condition. In the item of direction of another vehicle in the intention 155, a case where the other vehicle exists on a backward side of the vehicle V is set as condition. In a case where the respective conditions of the intention 155 are satisfied, intention of a signal of the other vehicle can be estimated as the intention 155 of “please give me way”. For example, information indicating intention such as “please give me way” is set to the item of intention information of the intention 155.

For example, in the traffic situation item of the intention 156, a traffic situation in which other vehicles are stopped in a line on a backward side in the same lane while the host vehicle is stopped is set as a condition. In the item of illumination state of another vehicle in the intention 156, a situation in which the other vehicle performs passing is set as a condition. In the item of direction of another vehicle in the intention 156, a case where the other vehicle exists on a backward side of the vehicle V is set as a condition. In a case where the respective conditions of the intention 156 are satisfied, intention of a signal of the other vehicle can be estimated as the intention 156 in which the vehicle V is encouraged to travel straight ahead. For example, information indicating intention such as “a front vehicle has moved, please move early” is set to the item of intention information of the intention 156.

In this embodiment, with regard to the in-vehicle system 1, description has been given of a case where the control device 15 stores the estimation information 150 for estimating the intention 151 to the intention 156 in the storage unit 15B, but there is no limitation to the case. For example, the control device 15 may acquire the estimation information 150 from the Internet and the like in the case of estimating intention of a signal of another vehicle. In addition, the estimation information 150 may add information indicating new intention that is learned on the basis of the traffic situation and the illumination state of the other vehicle.

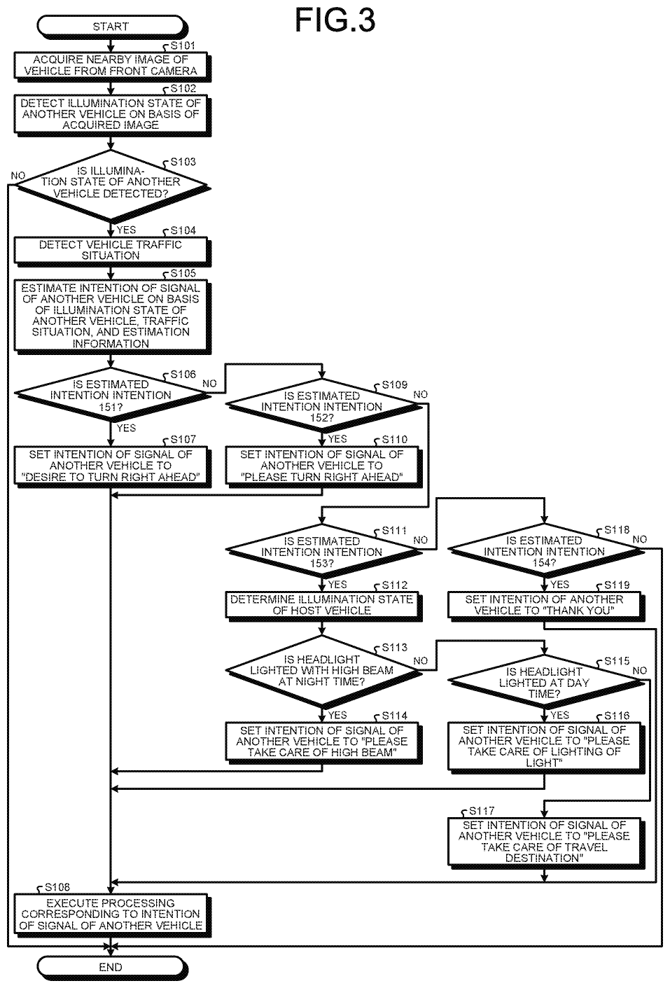

Next, an example of control of the processing unit 15C of the control device 15 will be described with reference to a flowchart of FIG. 3. The flowchart illustrated in FIG. 3 illustrates an example of a procedure of estimating intention of a signal of another vehicle in front of the vehicle V. The procedure illustrated in FIG. 3 is realized when the processing unit 15C executes a program. The procedure illustrated in FIG. 3 is repetitively executed by the processing unit 15C. For example, the procedure illustrated in FIG. 3 is repetitively executed by the processing unit 15C at a control cycle of several ms or several tens of ms (clock unit).

First, the processing unit 15C of the control device 15 in the in-vehicle system 1 acquires a nearby image of the vehicle V from the front camera 12da (Step S101). The processing unit 15C detects an illumination state of another vehicle on the basis of the image that is acquired (Step S102). For example, the processing unit 15C detects the other vehicle from the image through pattern matching and the like, and detects the illumination state of a headlight, a direction indicator, and the like of the other vehicle. The processing unit 15C stores a detection result indicating whether or not the illumination state of the other vehicle can be detected in the storage unit 15B. For example, in a case where signals of passing, winker, and hazard of the other vehicle can be detected from the image, the processing unit 15C stores a detection result indicating that the illumination state of the other vehicle is detected in the storage unit 15B. The processing unit 15C functions as the first detection unit 15C2 by executing the processing in Step S102. When the detection result is stored in the storage unit 15B, the processing unit 15C causes the processing to proceed to Step S103.

The processing unit 15C determines whether or not the illumination state of the other vehicle is detected with reference to the detection result in the storage unit 15B (Step S103). In a case where it is determined that the illumination state of the other vehicle is not detected (No in Step S103), the processing unit 15C terminates the procedure illustrated in FIG. 3. In a case where it is determined that the illumination state of the other vehicle is detected (Yes in Step S103), the processing unit 15C causes the processing to proceed to Step S104.

The processing unit 15C detects a traffic situation of the vehicle V (Step S104). For example, the processing unit 15C detects traffic situations including a location in which the vehicle V travels, a relative relationship between the vehicle V and the nearby other vehicle, a travel state, and the like on the basis of a video (image) captured by the front camera 12da, current position information of the vehicle V which is detected by the GPS receiver 12c, map information, and the like. In this embodiment, the processing unit 15C detects a traffic situation indicating any one of the intention 151 to the intention 154 of the estimation information 150. The processing unit 15C stores information indicating the detected traffic situation in the storage unit 15B. The processing unit 15C functions as the second detection unit 15C3 by executing the processing in Step S104. When the detection result is stored in the storage unit 15B, the processing unit 15C causes the processing to proceed to Step S105.

The processing unit 15C estimates intention of a signal of the other vehicle on the basis of the illumination state of the other vehicle, the traffic situation, and the estimation information 150 (Step S105). For example, the processing unit 15C estimates intention, which is the same as or similar to the illumination state of the other vehicle and the traffic situation, among the intention 151 to the intention 156 of the estimation information 150. The processing unit 15C functions as the estimation unit 15C4 by executing the processing in Step S105. When estimating the intention of the signal of the other vehicle, the processing unit 15C causes the processing to proceed to Step S106.

The processing unit 15C determines whether or not the estimated intention is the intention 151 on the basis of the estimated result (Step S106). In a case where it is determined that the determined intention is the intention 151 (Yes in Step S106), the processing unit 15C causes the processing to proceed to Step S107. The processing unit 15C sets the intention of the signal of the other vehicle to “desire to turn right ahead” on the basis of the intention information of the estimation information 150 (Step S107). When the intention of the signal of the other vehicle is stored in the storage unit 15B, the processing unit 15C causes the processing to proceed to Step S108.

The processing unit 15C executes processing corresponding to the intention of the signal of the other vehicle (Step S108). For example, the processing unit 15C outputs information indicating the estimated intention of the signal of the other vehicle to the display device 13. As a result, the display device 13 displays the information indicating the intention of the signal of the other vehicle which is estimated by the processing unit 15C of the control device 15. For example, the processing unit 15C executes processing of controlling travel, stoppage, and the like of the vehicle V which correspond to the estimated intention of the signal of the other vehicle. For example, in a case where the intention of the signal of the other vehicle is “desire to turn right ahead”, the processing unit 15C executes processing of performing control of stopping the vehicle V. When the processing is executed, the processing unit 15C terminates the procedure illustrated in FIG. 3.

In a case where it is determined that the estimated intention is not the intention 151 (No in Step S106), the processing unit 15C causes the processing to proceed to Step S109. The processing unit 15C determines whether or not the estimated intention is the intention 152 on the basis of the estimated result in Step S105 (Step 3109). In a case where it is determined that the estimated intention is the intention 152 (Yes in Step S109), the processing unit 15C causes the processing to proceed to Step S110. The processing unit 15C sets the intention of the signal of the other vehicle to “please turn right ahead” on the basis of the intention information of the estimation information 150 (Step S110). When the intention of the signal of the other vehicle is stored in the storage unit 15B, the processing unit 15C causes the processing to proceed to Step S108 described above.

The processing unit 15C executes processing corresponding to the intention of the signal of the other vehicle (Step S108). For example, the processing unit 15C outputs information in which the intention of the signal of the other vehicle indicates “please turn right ahead” to the display device 13. For example, the processing unit 15C executes processing of performing control of causing the vehicle V to turn right. The processing unit 15C functions as the travel control unit 15C5 and the output control unit 15C6 by executing the processing in Step S108. When the processing is executed, the processing unit 15C terminates the procedure illustrated in FIG. 3.

In a case where it is determined that the estimated intention is not the intention 152 (No in Step S109), the processing unit 15C causes the processing to proceed to Step S111. The processing unit 15C determines whether or not the estimated intention is the intention 153 on the basis of the estimated result in the Step S105 (Step S111). In a case where it is determined that the estimated intention is the intention 153 (Yes in Step S111), the processing unit 15C causes the processing to proceed to Step S112.

The processing unit 15C determines an illumination state of the host vehicle (Step S112). For example, the processing unit 15C acquires an operation state of the headlight of the vehicle V by the headlight switch 12g through the interface unit 15A. The processing unit 15C determines whether it is day time or night time on the basis of date, illuminance at the periphery of the vehicle V which is detected by the illuminance sensor 12f. In addition, the processing unit 15C determines whether or not a headlight 12h is lighted with a high beam at night time, whether or not the headlight 12h is lighted at day time, and the like on the basis of the acquired operation state of the headlight 12h, and stores the determination result in the storage unit 15B. When the determination is terminated, the processing unit 15C causes the processing to proceed to Step S113.

The processing unit 15C determines whether or not the headlight of the vehicle V is lighted with a high beam at night time on the basis of the determination result in Step S112 (Step S113). In a case where it is determined that the headlight is lighted with a high beam at night time (Yes in Step S113), the processing unit 15C causes the processing to proceed to Step S114. The processing unit 15C sets the intention of the signal of the other vehicle to “please take care of a high beam” (Step S114). When the intention of the signal of the other vehicle is stored in the storage unit 15B, the processing unit 15C causes the processing to proceed to Step S108.

The processing unit 15C executes processing corresponding to the intention of the signal of the other vehicle (Step S108). For example, the processing unit 15C outputs information in which the intention of the signal of the other vehicle indicates “please take care of a high beam” to the display device 13. For example, the processing unit 15C executes processing of performing control of switching the headlight 12h of the vehicle V from the high beam to a low beam. When the processing is executed, the processing unit 15C terminates the procedure illustrated in FIG. 3.

In a case where it is determined that the headlight is not lighted with the high beam at night time on the basis of the determination result in Step S112 (No in Step S113), the processing unit 15C causes the processing to proceed to Step S115. The processing unit 15C determines whether or not the headlight 12h is lighted at day time (Step S115). In a case where it is determined that the headlight 12h is lighted at day time (Yes in Step S115), the processing unit 15C causes the processing to proceed to Step S116. The processing unit 15C sets the intention of the signal of the other vehicle to “please take care of lighting of a light” on the basis of the intention information of the estimation information 150 (Step S116). When the intention of the signal of the other vehicle is stored in the storage unit 15B, the processing unit 15C causes the processing to proceed to Step S108.

The processing unit 15C executes processing corresponding to the intention of the signal of the other vehicle (Step S108). For example, the processing unit 15C outputs information in which the intention of the signal of the other vehicle indicates “please take care of lighting of a light” to the display device 13. For example, the processing unit 15C executes processing of performing control of turning off the headlight 12h of the vehicle V. When the processing is executed, the processing unit 15C terminates the procedure illustrated in FIG. 3.

In a case where it is determined that the headlight 12h is not lighted at day time (No in Step S115), the processing unit 15C causes the processing to proceed to Step S117. The processing unit 15C sets the intention of the signal of the other vehicle to “please take care of a travel destination” on the basis of the intention information of the estimation information 150 (Step S117). When the intention of the signal of the other vehicle is stored in the storage unit 15B, the processing unit 15C causes the processing to proceed to Step S108.

The processing unit 15C executes processing corresponding to the intention of the signal of the other vehicle (Step S108). For example, the processing unit 15C outputs information in which the intention of the signal of the other vehicle indicates “please take care of a travel destination” to the display device 13. For example, the processing unit 15C allows the operation of the vehicle V to continue. When the processing is performed, the processing unit 15C terminates the procedure illustrated in FIG. 3.

In a case where it is determined that the estimated intention in Step S111 is not the intention 153 (No in Step S111), the processing unit 15C causes the processing to proceed to Step S118. The processing unit 15C determines whether or not the estimated intention is the intention 154 on the basis of the estimated result in Step S105 (Step S118). In a case where it is determined that the estimated intention is not the intention 154 (No in Step S118), the processing unit 15C terminates the procedure illustrated in FIG. 3. In a case where it is determined that the estimated intention is the intention 154 (Yes in Step S118), the processing unit 15C causes the processing to proceed to Step S119. The processing unit 15C sets the intention of the signal of the other vehicle to “thank you” on the basis of the intention information of the estimation information 150 (Step S119). When the intention of the signal of the other vehicle is stored in the storage unit 15B, the processing unit 15C causes the processing to proceed to Step S108.

The processing unit 15C executes processing corresponding to the intention of the signal of the other vehicle (Step S108). For example, the processing unit 15C outputs information in which the intention of the signal of the other vehicle indicates “thank you” to the display device 13. For example, the processing unit 15C allows the operation of the vehicle V to continue. When the processing is executed, the processing unit 15C terminates the procedure illustrated in FIG. 3.

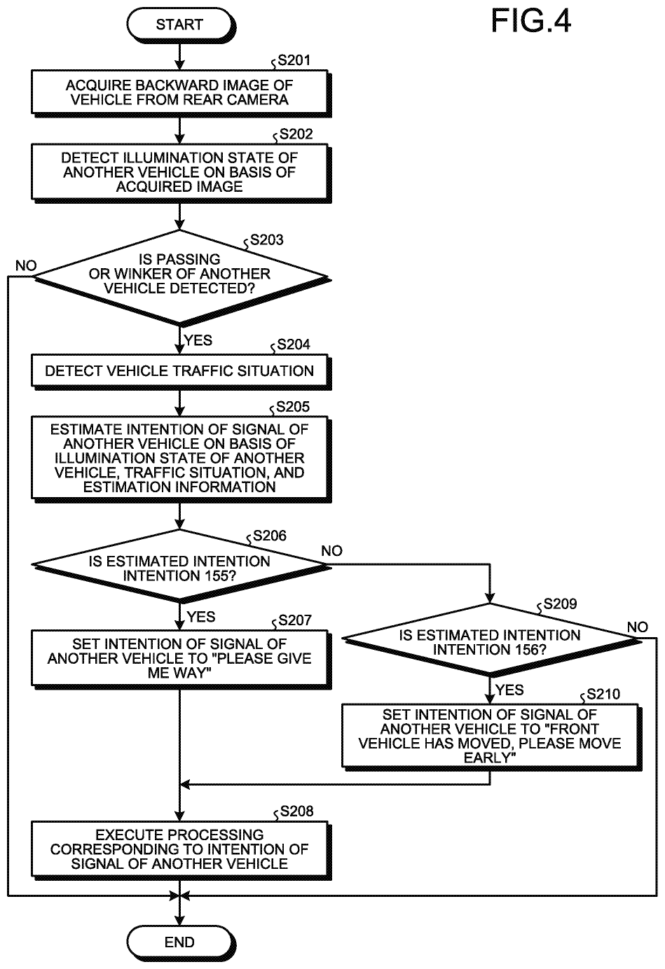

Next, an example of control of the processing unit 15C of the control device 15 will be described with reference to a flowchart of FIG. 4. The flowchart illustrated in FIG. 4 illustrates an example of a procedure of estimating intention of a signal of another vehicle on a backward side of the vehicle V. The procedure illustrated in FIG. 4 is realized when the processing unit 15C executes a program. The procedure illustrated in FIG. 4 is repetitively executed by the processing unit 15C. For example, the procedure illustrated in FIG. 4 is repetitively executed by the processing unit 15C at a control cycle of several ms or several tens of ms (clock unit).

First, the processing unit 15C of the control device 15 in the in-vehicle system 1 acquires a backward image of the vehicle V from the rear camera 12db (Step S201). The processing unit 15C analyzes detection of an illumination state of another vehicle on the basis of the image that is acquired (Step S202). For example, the processing unit 15C detects another vehicle on a backward side from the image through pattern matching and the like, and detects an illumination state of a headlight, a direction indicator, and the like of the other vehicle. The processing unit 15C stores a detection result indicating whether or not the illumination state of the other vehicle can be detected in the storage unit 15B. For example, in a case where signals of passing and winker of the other vehicle can be detected from the image, the processing unit 15C stores a detection result indicating that the illumination state of the other vehicle is detected in the storage unit 15B. The processing unit 15C functions as the first detection unit 15C2 by executing the processing in Step S202. When the detection result is stored in the storage unit 15B, the processing unit 15C causes the processing to proceed to Step S203.

The processing unit 15C determines whether or not passing or winker of the other vehicle is detected on the basis of the detection result in the storage unit 15B (Step S203). In a case where it is determined that the passing or winker of the other vehicle is not detected (No in Step S203), the processing unit 15C terminates the procedure illustrated in FIG. 4. In a case where it is determined that passing or winker of the other vehicle is detected (Yes in Step S203), the processing unit 15C causes the processing to proceed to Step S204.

The processing unit 15C detects a traffic situation of the vehicle V (Step S204). For example, the processing unit 15C detects traffic situations including a location in which the vehicle V travels, a relative relationship between the vehicle V and the nearby other vehicle, a travel state, and the like on the basis of a video (image) captured by the rear camera 12db, current position information of the vehicle V which is detected by the GPS receiver 12c, map information, and the like. In this embodiment, the processing unit 15C detects a traffic situation indicating any one of the intention 155 and the intention 156 of the estimation information 150. The processing unit 15C stores information indicating the detected traffic situation in the storage unit 15B. The processing unit 15C functions as the second detection unit 15C3 by executing the processing in Step S204. When the detection result is stored in the storage unit 15B, the processing unit 15C causes the processing to proceed to Step S205.

The processing unit 15C estimates intention of a signal of the other vehicle on the basis of the illumination state of the other vehicle, the traffic situation, and the estimation information 150 (Step S205). For example, the processing unit 15C estimates intention, which is the same as or similar to the illumination state and a travel state of the other vehicle and the traffic situation, in the situations SC5 and SC6 of the estimation information 150. The processing unit 15C functions as the estimation unit 15C4 by executing the processing in Step S205. When estimating the intention of the signal of the other vehicle, the processing unit 15C causes the processing to proceed to Step S206.

The processing unit 15C determines whether or not the estimated intention is the intention 155 (Step S206). In a case where it is determined that the estimated intention is the intention 155 (Yes in Step S206), the processing unit 15C causes the processing to proceed to Step S207. The processing unit 15C sets the intention of the signal of the other vehicle to “please give me way” on the basis of the intention information of the estimation information 150 (Step S207). When the intention of the signal of the other vehicle is stored in the storage unit 15B, the processing unit 15C causes the processing to proceed to Step S208.

The processing unit 15C executes processing corresponding to the intention of the signal of the other vehicle (Step S208). For example, the processing unit 15C outputs information indicating the estimated intention of the signal of the other vehicle to the display device 13. As a result, the display device 13 displays the information indicating the intention of the signal of the other vehicle which is estimated by the processing unit 15C of the control device 15. For example, the processing unit 15C executes processing of controlling travel, stoppage, and the like of the vehicle V which correspond to the estimated intention of the signal of the other vehicle. For example, in a case where the intention of the signal of the other vehicle is “please give me way”, the processing unit 15C executes processing of performing control of stopping the vehicle V, or processing of performing control of changing a lane of the vehicle V. For example, the processing unit 15C may make a signal indicating a gist of “giving of way” with respect to the other vehicle. The processing unit 15C functions as the travel control unit 15C5 and the output control unit 15C6 by executing processing in Step S208. When the processing is executed, the processing unit 15C terminates the procedure illustrated in FIG. 4.

In a case where it is determined that the estimated intention is not the intention 155 (No in Step S206), the processing unit 15C causes the processing to proceed to Step S209. The processing unit 15C determines whether or not the intention estimated in Step S205 is the intention 156 (Step S209). In a case where it is determined that the estimated intention is not the intention 156 (No in Step S209), the processing unit 15C terminates the procedure illustrated in FIG. 4.

In a case where it is determined that the estimated intention is the intention 156 (Yes in Step S209), the processing unit 15C causes the processing to proceed to Step S210. The processing unit 15C estimates the intention of the signal of the other vehicle as “a front vehicle has moved, please move early” on the basis of the intention information of the estimation information 150 (Step S210). When the intention of the signal of the other vehicle is stored in the storage unit 15B, the processing unit 15C causes the processing to proceed to Step S208.

The processing unit 15C executes processing corresponding to the intention of the signal of the other vehicle (Step S208). For example, the processing unit 15C outputs information in which the intention of the signal of the other vehicle indicates “a front vehicle has moved, please move early” to the display device 13. For example, the processing unit 15C executes processing of performing control of advancing the vehicle V that is stopped. When the processing is executed, the processing unit 15C terminates the procedure illustrated in FIG. 4.

In the above-described in-vehicle system 1, the intention of the signal of the other vehicle is estimated on the basis of the illumination state of the other vehicle and the traffic situation of vehicles, and thus it is not necessary to perform communication with the other vehicle to confirm the signal of the other vehicle. Accordingly, the in-vehicle system 1 can estimate the signal intention from the signal of the other vehicle without performing communication with the other vehicle, and thus a system configuration is simplified and erroneous recognition of signals can be suppressed.

For example, in a case where the vehicle V is in automatic driving, even when another vehicle that is in manual driving and is driven by a driver makes a signal, the in-vehicle system 1 can perform automatic driving corresponding to the intention of the signal of the driver. Accordingly, the in-vehicle system 1 can consider a signal of another vehicle that is manually driven and travels at the periphery of the host vehicle, and thus communication with a driver of the other vehicle is possible, and safety can be improved. In addition, the in-vehicle system 1 displays intention of the signal of the other vehicle, and thus it is possible to allow an occupant of the vehicle V in the automatic driving to understand the intention of the automatic driving.

The in-vehicle system 1 estimates intention of a signal by distinguishing another vehicle in front of the host vehicle and other vehicle on a backward side from each other, and thus it is possible to accurately analyze a traffic situation of the host vehicle in consideration of a relative relationship between the host vehicle and the other vehicle. Accordingly, the in-vehicle system 1 can improve accuracy of estimation of the intention of the signal of the other vehicle from an image obtained by capturing a nearby image of the host vehicle.

The in-vehicle system 1 estimates the intention of the signal of the other vehicle on the basis of the illumination state of the other vehicle, the traffic situation of the host vehicle, and the illumination state of the headlight of the host vehicle, and thus it is also possible to estimate a signal of the other vehicle with respect to the headlight of the vehicle V. Accordingly, the in-vehicle system 1 can further improve estimation accuracy of the intention of the signal of the other vehicle.

Furthermore, the in-vehicle system 1 according to the embodiment of the invention is not limited to the above-described embodiment, and various modifications can be made within a range described in the appended claims.

In the above-described embodiment, description has been given of a case where the in-vehicle system 1 displays the estimation result of the signal of the other vehicle in the case of an automatic driving system, but there is no limitation to the case. For example, in the case of the automatic driving system, the in-vehicle system 1 may not output information indicating the estimation result of the signal of the other vehicle.

In the above-described embodiment, description has been given of a case where the in-vehicle system 1 is an automatic driving system without a driver, but there is no limitation to the case. For example, the in-vehicle system 1 may be mounted on a vehicle that is driven by a driver. In this case, in the in-vehicle system 1, when another vehicle makes a signal, intention of the signal is displayed to the driver. Accordingly, it is possible to allow the driver to accurately understand the intention of the signal, and it is possible to prevent the intention from being overlooked.

The in-vehicle system 1 may detect sounds such as horn of the other vehicle with a microphone and the like, and may add a detected sound as one of situation estimation factors. In other words, the in-vehicle system 1 may estimate the intention of the signal on the basis of the illumination state of the other vehicle and a sound that is emitted from the other vehicle.

In the in-vehicle system 1, at least one of the first detection unit 15C2 and the second detection unit 15C3 may detect the illumination state of the other vehicle or the traffic situation of the vehicle V by using the artificial intelligence technologies or the deep learning technologies which are known.

In the above-described control device 15, respective units may be individually constructed, and the respective units may be connected in a manner capable of transmitting and receiving various electric signals. In addition, partial functions may be realized by another control device. In addition, the above-described program, application, various pieces of data, and the like may be appropriately updated, or may be stored in a server that is connected to the in-vehicle system 1 through an arbitrary network. For example, the entirety or parts of the above-described program, application, and various pieces of data, and the like may be downloaded as necessary. In addition, for example, with regard to the processing function of the control device 15, the entirety or arbitrary parts thereof may be executed, for example, by a CPU and the like, and a program that is analyzed and executed by the CPU and the like, or may be realized as hardware by a wired logic and the like.

The in-vehicle system according to the embodiment can estimate intention of a signal of other vehicles from an image obtained by capturing a nearby image of a vehicle. As a result, it is possible to attain an effect in which it is not necessary for the in-vehicle system to perform communication with other vehicles to confirm signals of the other vehicles.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An in-vehicle system, comprising:
a first detection unit that detects an illumination state of another vehicle on the basis of an image obtained by capturing a nearby image of a vehicle;
a second detection unit that detects a traffic situation of the vehicle;
an estimation unit that estimates intention of a signal of the other vehicle on the basis of the illumination state of the other vehicle that is detected by the first detection unit and the traffic situation of the vehicle that is detected by the second detection unit; and
an operation unit that performs processing corresponding to the intention of the signal of the other vehicle that is estimated by the estimation unit, wherein
the operation unit controls automatic travel of the vehicle on the basis of the intention of the signal of the other vehicle that is estimated by the estimation unit.

2. The in-vehicle system according to claim 1, wherein
the operation unit controls outputting of information indicating the intention of the signal of the other vehicle that is estimated by the estimation unit.

3. The in-vehicle system according to claim 1, further comprising:
a front camera that captures an image in front of the vehicle, and a rear camera that captures an image on a backward side of the vehicle, wherein
the first detection unit detects the illumination state of the other vehicle on the basis of at least one of the image captured by the front camera and the image captured by the rear camera.

4. The in-vehicle system according to claim 2, further comprising:
a front camera that captures an image in front of the vehicle, and a rear camera that captures an image on a backward side of the vehicle, wherein
the first detection unit detects the illumination state of the other vehicle on the basis of at least one of the image captured by the front camera and the image captured by the rear camera.

5. The in-vehicle system according to claim 1, wherein
the estimation unit estimates the intention of the signal of the other vehicle on the basis of the illumination state of the other vehicle that is detected by the first detection unit, the traffic situation of the vehicle that is detected by the second detection unit, and an illumination state of a headlight of the vehicle.

6. The in-vehicle system according to claim 2, wherein
the estimation unit estimates the intention of the signal of the other vehicle on the basis of the illumination state of the other vehicle that is detected by the first detection unit, the traffic situation of the vehicle that is detected by the second detection unit, and an illumination state of a headlight of the vehicle.

7. The in-vehicle system according to claim 3, wherein
the estimation unit estimates the intention of the signal of the other vehicle on the basis of the illumination state of the other vehicle that is detected by the first detection unit, the traffic situation of the vehicle that is detected by the second detection unit, and an illumination state of a headlight of the vehicle.
